(19) United States
(12) Patent Application Publication
(10) Pub. No.: US 2016/0016299 A1
(43) Pub. Date: Jan. 21, 2016

(54) APPARATUS FOR INSTALLING UNDER-SINK MOUNTED APPLIANCES

(71) Applicants: PAUL EKEBERG, VANCOUVER, WA (US); BOB E. SECKER, VANCOUVER, WA (US)

(72) Inventors: PAUL EKEBERG, VANCOUVER, WA (US); BOB E. SECKER, VANCOUVER, WA (US)

(21) Appl. No.: 14/668,907

(22) Filed: Mar. 25, 2015

Related U.S. Application Data
(60) Provisional application No. 61/970,277, filed on Mar. 25, 2014.

(51) Int. Cl. B25B 27/16; E03C 1/266

(52) U.S. Cl. CPC B25B 27/16; E03C 1/2665

(57) ABSTRACT

Apparatus and methods for installing under-sink mounted appliances includes an elongated member extending, a shoe rotatingly couplable to the elongated member proximate its second end and including a central portion and opposed shoulders to engage against the interior parts of an appliance, a centering portion slidingly mountable to the elongated member to align the apparatus and appliance and support the appliance weight, and a locking portion selectively engagable against the elongated member.

### CROSS-REFERENCE TO RELATED APPLICATIONS

This application is a nonprovisional of, and claims priority to, co-pending U.S. Provisional Patent Application Ser. No. 61/970,277 filed Mar. 25, 2014, the disclosure of which is hereby incorporated by reference in its entirety.

### FIELD OF THE INVENTION

The present invention relates to apparatus for installing under-sink-mounted appliances and fixtures. More particularly, the present invention relates to an apparatus useful for aligning and installing under-sink garbage disposals.

### BACKGROUND

Appliances such as garbage disposals and sediment traps are frequently mounted below a kitchen or utility sink directly to the sink drain connection, or indirectly but inline with the sink drain connection. Mounting such appliances generally requires that the appliance be held in place against the underside drain connection, properly aligned, while a threaded clamp is tightened around the sink drain connector. Proper alignment and compression of the appliance connection portion and sealing gasket against the sink drain connection are critical to prevent leakage from an appliance, and to prevent excessive vibration from appliances such as electric disposals. This requires either two people—one to hold the appliance in place and properly aligned—or, if only one person is available, the appliance has to be jury-rigged in place somehow while the person connects it. The weight and awkward posture required to hold the appliance while installing causes injuries and improper installations. The installers frequently don't notice that the appliance is becoming misaligned in relation to the drain because they are looking at the appliance from below the sink and the side of the appliance rather than from above through the drain itself. When the misalignment is discovered, the installer(s) must repeat the process. Plumbers are generally paid by the hour, so the cost may end up far higher than anticipated. The difficulty and requirement for two people to install—or some sort of jury-rig—render the installation difficult for the average do-it-yourselfer homeowner.

Thus, there is a need for an apparatus that: (1) can quickly align an under-sink-mounted appliance to a drain connection and hold the appliance in place against the drain connection—properly aligned—while the final connection is made; (2) requires only a single person to use; (3) requires a minimum of skill; (4) is compact and lightweight; (5) easily manufactured; (6) easily stored; (7) compatible with standard drain sizes or easily adapted to non-standard sizes; (8) prevents ergonomic safety problems.

### SUMMARY OF THE INVENTION

An apparatus for installing under-sink mounted appliances generally includes: an elongated member, a shoe couplable to the elongated member and having opposed shoulders to engage the interior throat of an appliance for lifting and a central portion to center the shoe relative to the appliance coupling, and a centering portion also couplable to the elongated member for centering the apparatus and appliance to a sink drain fitting or other fitting, and a locking portion with the centering portion to automatically hold the appliance in place during coupling and to prevent dropping during lifting.

The elongated member may be rigid or flexible, and may consist of a linear rack having gear teeth disposed along its operative length engagable to corresponding teeth on the locking portion.

The apparatus is sized to correspond to a selected fitting or standardized fitting types.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

FIG. 1 shows a side view of a First Embodiment in use, with shoe portion being inserted into the appliance.

FIG. 2 shows another side view of a First Embodiment in use, with shoe portion being inserted into the appliance.

FIG. 3 shows a side view of a First Embodiment in use, with shoe portion engaged but centering portion not yet engaged.

FIG. 4 shows another side view of a First Embodiment in use, with shoe portion engaged but centering portion not yet engaged.

FIG. 5 shows a side view of a First Embodiment in use, with shoe and centering portions engaged, prepared for lifting the appliance

FIG. 6 shows another side view of a First Embodiment in use, with shoe and centering portions engaged, prepared for lifting the appliance.

FIG. 7 shows a side view of a First Embodiment in use, mid-lift.

FIG. 8 shows another side view of a First Embodiment in use, mid-lift.

FIG. 9 shows a side view of a First Embodiment in use, after the appliance is connected and with centering portion raised.

FIG. 10 shows another side view of a First Embodiment in use, after the appliance is connected and with centering portion raised.

FIG. 11 shows a side view of a First Embodiment in use, withdrawing the apparatus after connecting the appliance.

FIG. 12 shows another side view of a First Embodiment in use, withdrawing the apparatus after connecting the appliance.

FIG. 13 shows an exploded view of a centering portion and locking portion of a First Embodiment.

FIG. 14 shows a top perspective view of a shoe and coupling of a First Embodiment.

FIG. 15 shows an exploded view of a shoe and coupling of a First Embodiment.

FIG. 16 shows a perspective view of a shoe of a Second Embodiment, in the in-line orientation.

FIG. 17 shows a side view of a shoe of a Second Embodiment, in the deployed orientation.

FIG. 18 shows a top perspective view of a shoe of a Third Embodiment.

FIG. 19 shows bottom perspective view of a shoe of a Third Embodiment.

FIG. 20 shows another bottom perspective view of a shoe of a Third Embodiment.

FIG. 21 shows another top perspective view of a shoe of a Third Embodiment.

FIG. 22 shows a side view of a Fourth Embodiment in use with shoe and centering portions engaged, prepared for lifting the appliance.

FIG. 23 shows a side view of a Fourth Embodiment in use with appliance lifted into place.

FIG. 24 shows a top perspective view of a Fourth Embodiment, with latch disengaged.

FIG. 25 shows another top perspective view of a Fourth Embodiment, with latch engaged.

FIG. 26 shows a cutaway side view of a Fourth Embodiment, with latch disengaged.

FIG. 27 shows another cutaway side view of a Fourth Embodiment, with latch engaged.

FIG. 28 shows a top perspective view of a shoe portion of a Fourth Embodiment.

FIG. 29 shows a top view of a shoe portion of a Fourth Embodiment.

FIG. 30 shows a side view of a shoe portion of a Fourth Embodiment.

FIG. 31 shows an end view of a shoe portion of a Fourth Embodiment.

FIG. 32 shows a top perspective view of a centering portion of a Fourth Embodiment.

FIG. 33 shows a bottom perspective view of a centering portion of a Fourth Embodiment.

FIG. 34 shows a cutaway side view of a latch of a Fourth Embodiment.

FIG. 35 shows another cutaway side view of a latch of a Fourth Embodiment.

FIG. 36 shows a side view of a latch of a Fourth Embodiment.

FIG. 37 shows a top perspective view of a latch of a Fourth Embodiment.

### REFERENCE NUMBERS USED IN DRAWINGS

The following numbering is used throughout the various drawing figures:
10 First Embodiment
12 Elongated Member
14 Elongated Member First End
16 Elongated Member Second End
18 Shoe
20 Centering Portion
22 Locking Portion
24 Shoe Central Portion
26 First Shoulder Portion
28 Second Shoulder Portion
30 First Shoulder Portion Terminal End
32 Second Shoulder Portion Terminal End
34 First Shoulder Portion Top Engagement Surface
36 Second Shoulder Portion Top Engagement Surface
38 Elongated Member Gear Teeth
40 Elongated Member First Surface
42 Elongated Member Second Surface
44 Latch
46 Locking Mechanism Biasing Portion
48 Latch First Manual Tab
50 Latch Second Manual Tab
52 Latch Engagement Surface
54 Latch First Engagement Tooth
56 Latch Second Engagement Tooth
58 Latch Biasing Member Guide
60 Latch Cavity
62 Latch Cavity Cover Plate
64 Latch Cavity First Sidewall
66 Latch Cavity Second Sidewall
68 Shoe Central Portion First Vertical Engagement Surface
70 Shoe Central Portion Second Vertical Engagement Surface
72 Shoe Central Portion Chord Radius
74 Rotational Coupling Axle Pin
76 Elongated Member Second End Rotational Coupling Bearing Race
78 Shoe Rotational Coupling Bearing Race
80 Rotational Coupling Pivot Axis
82 Receiving Slot
84 Aperture
86 Shoe First Cutout
88 Shoe Second Cutout
90 Elongated Member Handle
100 Centering Portion Aperture
102 Centering Portion First Vertical Engagement Surface
104 Centering Portion Second Vertical Engagement Surface
106 Centering Portion First Lateral Flange
108 Centering Portion Second Lateral Flange
110 Centering Portion Clamping Surface
1010 Second Embodiment
1012 Elongated Member
1014 Elongated Member First End
1016 Elongated Member Second End
1018 Shoe
1024 Shoe Central Portion
1026 First Shoulder Portion
1028 Second Shoulder Portion
1030 First Shoulder Portion Terminal End
1032 Second Shoulder Portion Terminal End
1034 First Shoulder Portion Top Engagement Surface
1036 Second Shoulder Portion Top Engagement Surface
1068 Shoe Central Portion First Vertical Engagement Surface
1070 Shoe Central Portion Second Vertical Engagement Surface
1072 Shoe Central Portion Chord Radius
1080 Rotational Coupling Pivot Axis
1082 Receiving Slot
2010 Third Embodiment
2018 Shoe
2026 First Shoulder Portion
2028 Second Shoulder Portion
2030 First Shoulder Portion Terminal End
2032 Second Shoulder Portion Terminal End
2034 First Shoulder Portion Top Engagement Surface
2036 Second Shoulder Portion Top Engagement Surface
2038 Elongated Member Gear Teeth
2068 Shoe Central Portion First Vertical Engagement Surface
2070 Shoe Central Portion Second Vertical Engagement Surface
2072 Shoe Central Portion Chord Radius
2078 Shoe Rotational Coupling Bearing Race
2080 Rotational Coupling Pivot Axis
2082 Receiving Slot
2084 Aperture
2092 Shoe Central Portion First Sidewall
2094 Shoe Central Portion Second Sidewall
3010 Fourth Embodiment
3012 Elongated Member
3014 Elongated Member First End
3016 Elongated Member Second End
3018 Shoe
3020 Centering Portion
3022 Locking Portion
3024 Shoe Central Portion
3026 First Shoulder Portion
3028 Second Shoulder Portion
3030 First Shoulder Portion Terminal End
3032 Second Shoulder Portion Terminal End
3034 First Shoulder Portion Top Engagement Surface
3036 Second Shoulder Portion Top Engagement Surface
3044 Latch
3048 Latch Manual Tab
3052 Latch Engagement Surface
3054 Latch Engagement Teeth
3060 Latch Cavity
3068 Shoe Central Portion First Vertical Engagement Surface
3070 Shoe Central Portion Second Vertical Engagement Surface
3072 Shoe Central Portion Chord Radius
3084 Shoe Aperture
3090 Elongated Member Handle
3096 Anchor
3098 Anchor Recess
3100 Centering Portion Aperture
3102 Centering Portion First Vertical Engagement Surface
3104 Centering Portion Second Vertical Engagement Surface
3106 Centering Portion First Lateral Flange
3108 Centering Portion Second Lateral Flange
3110 Centering Portion Clamping Surface
3112 Centering Portion Pawl Latch Axle

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

Generally, a sink S includes a drain with a drain cup C and a drain bottom connection D extending downward from the sink forming a pipe stub or similar connection point adapted to receive a selected appliance A. Drain connection D may include thread connectors, or a clamp connector, or may simply be adapted to receive a glued slip fitting or some other connector for mounting an under-sink appliance A. An under-sink-mounted appliance A will include a mounting collar or connector M adapted to connect to the drain connection D, and having a corresponding radius R_{M}. Terms such as “top”, “bottom”, “upper”, “lower”, and similar terms connote relative positions and directions as though the apparatus were being held vertically for normal use to lift a disposal into place under a drain.

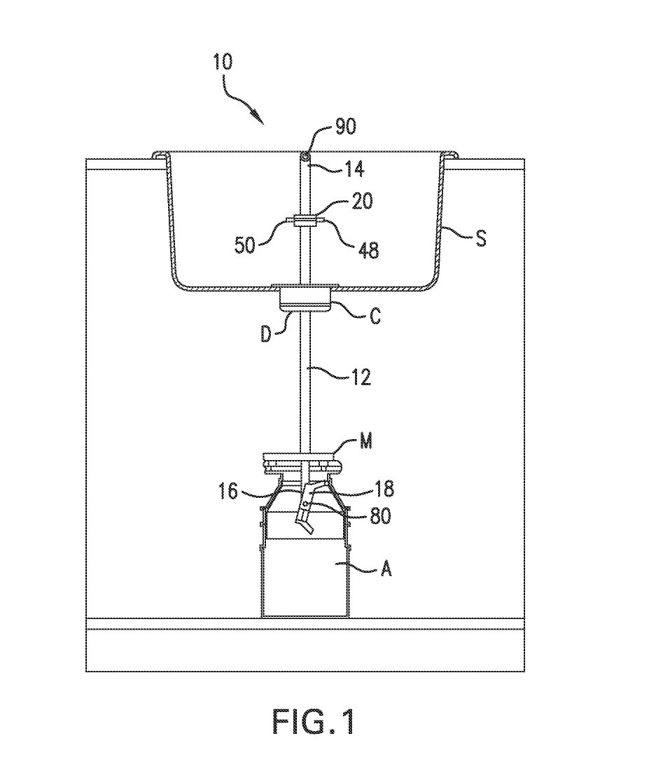

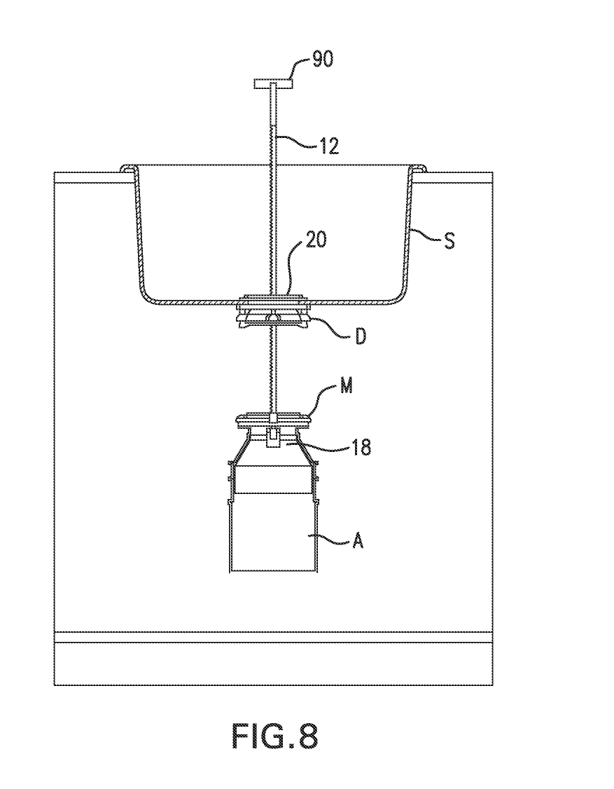

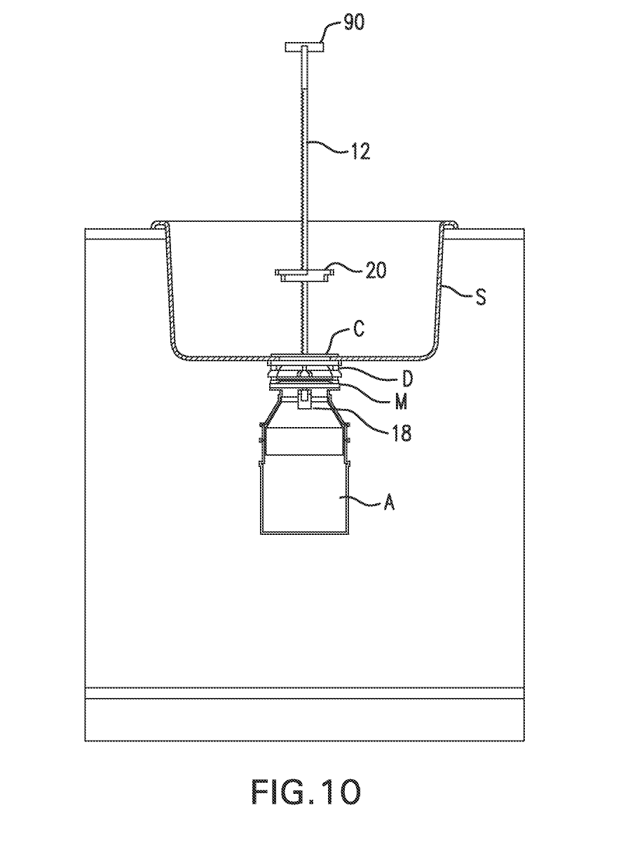

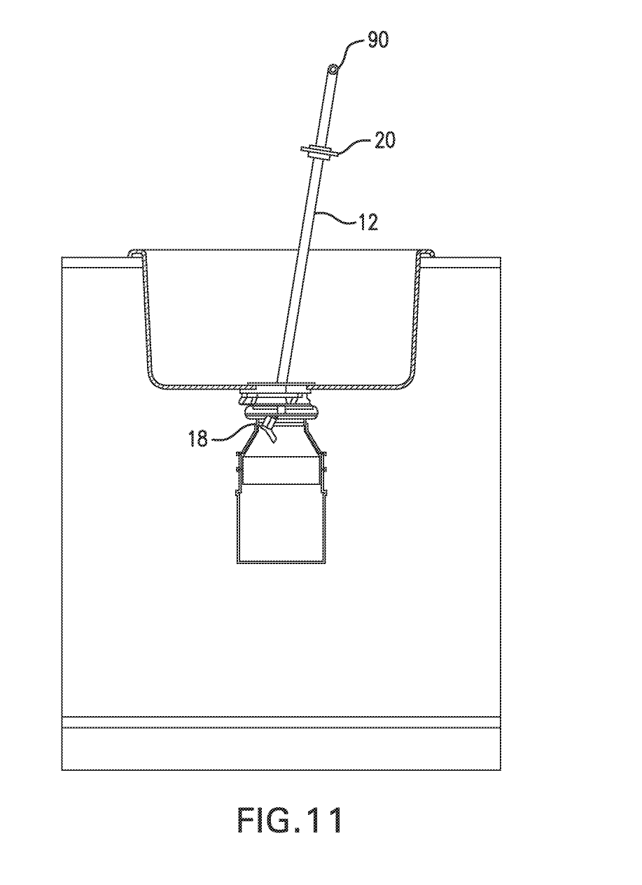

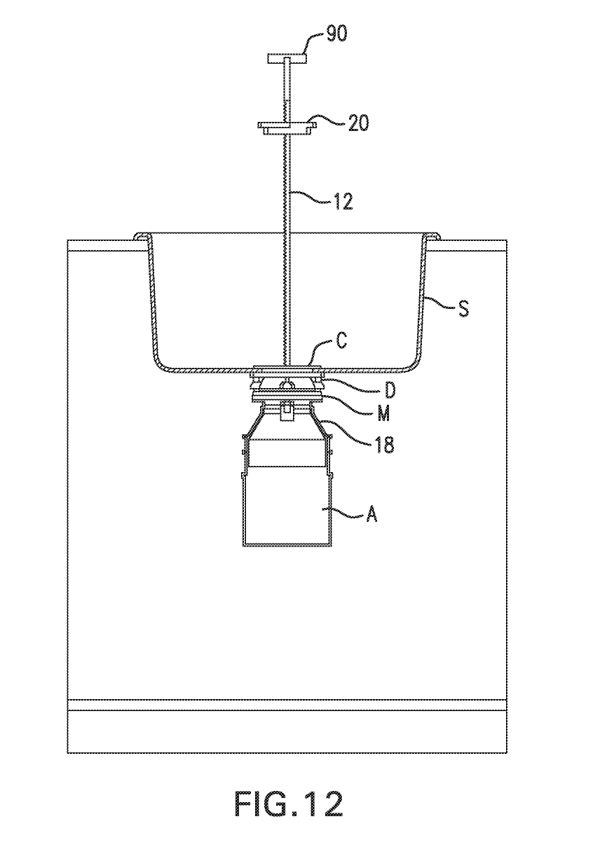

Referring to FIGS. 1-15, a first embodiment 10 is shown. A first embodiment 10 includes an elongated member 12 extending from a first end 14 to a second end 16, a shoe 18 couplable to elongated member 12 proximate elongated member second end 16, and a centering portion 20 slindingly mountable to elongated member 12 between the shoe 18 and the elongated member first end 14. Centering portion 20 includes a locking portion 22 selectively engagable along the elongated member 12 against the elongated member 12. Elongated member handle 90 is connected to elongated member 12 proximate first end 14.

Shoe 18 includes a central portion 24 and first and second shoulder portions 26, 28, respectively. Each shoulder portion 26, 28 extends from the central portion 24 to its respective terminal end 30, 32, respectively, distal from center portion 24. Each of first and second shoulder portions 26, 28 further includes a top engagement surface 34, 36, respectively.

In the embodiment, elongated member 12 is a linear rack having opposite first and second surfaces 40, 42, respectively, with a plurality of gear teeth 38 disposed along first surface 40 to engage latch 44. In the embodiment, elongated member 12 comprises a semi-rigid linear rack. In this context, “semi-rigid” means the member 12 can flex, but can also sustain both tensile and compressive axial force, as opposed to a strap or cable which can sustain tensile axial force but cannot sustain compressive axial force.

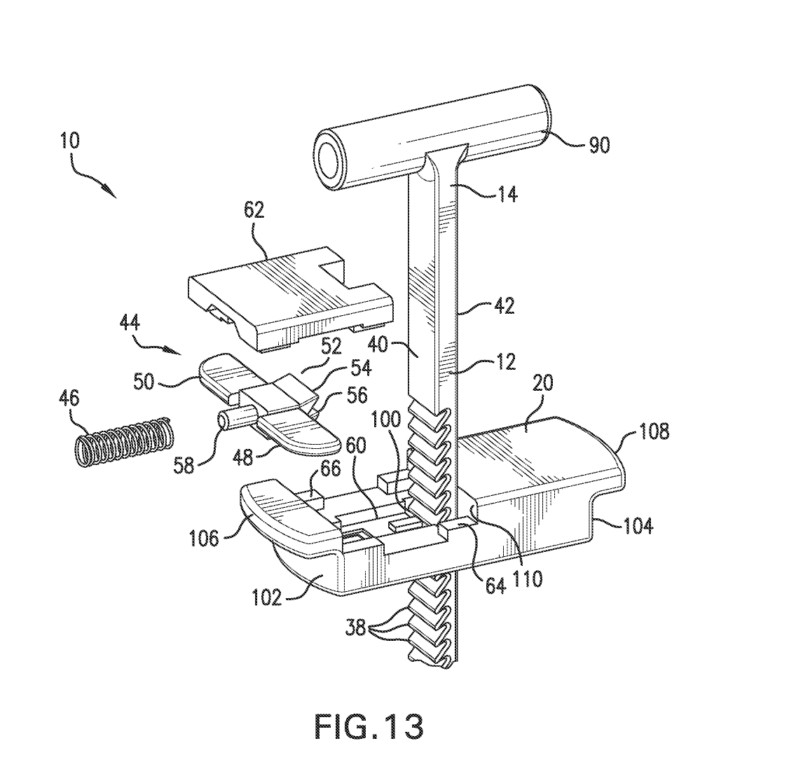

Referring again to FIGS. 1-15, and particularly to FIG. 13, centering portion 20 slindingly mounts to elongated member 12 through centering portion aperture 100. Centering portion 20 includes opposed first and second centering portion vertical engagement surfaces 102 and 104, respectively, and opposed first and second lateral flanges 106 and 108, respectively, extending radially outward beyond first and second centering portion vertical engagement surfaces 102, 104. The distance between first and second vertical engagement surfaces 102, 104 is approximately equal the interior diameter of a selected drain fitting, in this case approximately 3 inches (76 mm) corresponding to a standard domestic drain fitting.

In the embodiment, locking portion 22 includes latch 44 linearly movable along centering portion 20 between an engaged position and a disengaged position, and a biasing portion 46 disposed to bias latch 44 toward the engaged position. Latch 44 includes first and second manual tabs 48, 50, respectively, coupled to latch 44 and which extend outward from the centering portion 20 to be easily accessible for manual operation by the operator using one or two fingers. In the embodiment, biasing member 46 is a coil spring acting against latch 44. Latch 44 an engagement surface 52, with first and second engagement teeth 54, 56, respectively, disposed along engagement surface 52 to selectively engage elongated member gear teeth 38. Locking portion 22 includes clamping surface 110. In the embodiment, clamping surface 110 primarily acts as a guide to maintain alignment of elongated member 12 and gear teeth 38 for engagement with latch 44. Biasing member 46 and latch 44 also will tend to compress elongated member 12 against clamping surface 110 when engaged. In the embodiment, latch engagement teeth 54, 56 and elongated member gear teeth 38 are unidirectional, and oriented opposite each other to permit centering portion 20 to move freely along elongated member 12 toward its second end 16, but prevent movement toward its first end 14 unless latch 44 is moved to a disengaged position.

Biasing member guide 58 projects from latch 44, opposite of engagement surface 52, and biasing member 46 engages over guide 58 to assist retaining biasing member 46 against latch 44 and preventing biasing member 46 from buckling.

In the embodiment, locking portion 22, including latch 44 and biasing member 46, is retained within a latch cavity 60 within centering portion 20. Removable cover plate 62 snaps into place over latch cavity 60 to retain locking portion 22, including latch 44 and biasing member 46. With cover plate 62 in place, first and second manual tabs 48, 50 project through and slide within opposed slots defined by the lateral edges of cover plate 62 and corresponding first and second lateral sidewalls 64, 66, respectively, which define latch cavity 60. Provision of a horizontally sliding biased latch enhances safety and ergonomics, as locking portion 22 will automatically engage and lock elongated member 12 in place if upward pressure is released—e.g. if the operator's hand slips off handle 90. Additionally, the horizontal latch arrangement reduces backlash associated with the pawl latch described in the Fourth Embodiment, thereby holding appliance A more tightly in place against drain D for connection.

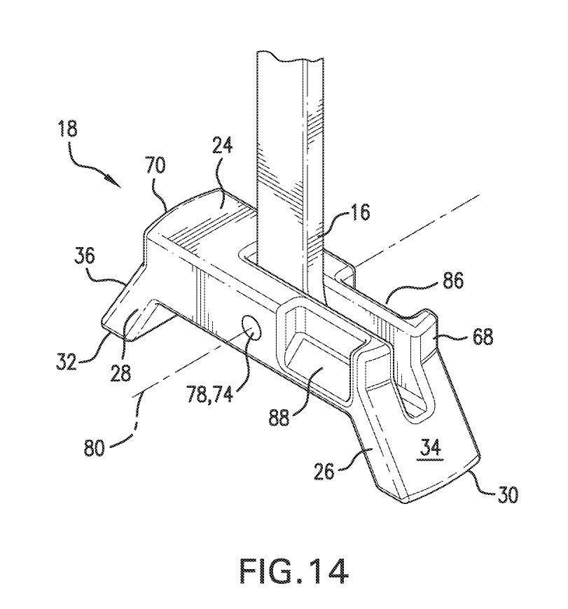

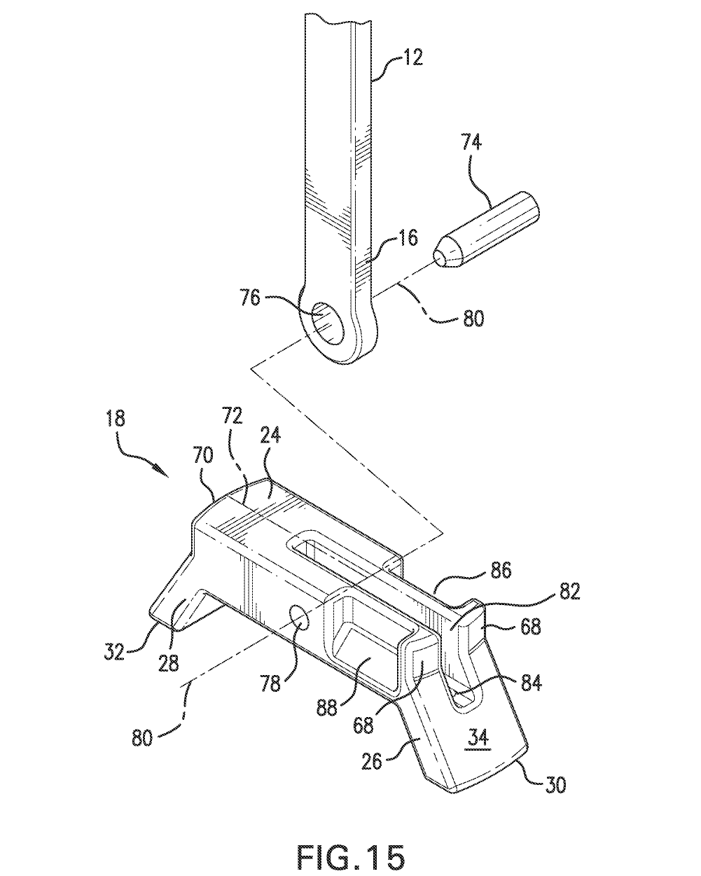

Referring again to FIGS. 1-15, and particularly to FIGS. 14-15, in the First Embodiment 10, shoe 18 first and second shoulder portion top engagement surfaces 34, 36 slope downward away from central portion 24 and toward their respective terminal ends 30, 32. Shoe central portion 24 includes first and second vertical engaging surfaces 68, 70, respectively, disposed opposite each other and extending upward from the respective shoulders 26, 28, proximate the area where the respective shoulders project from the central portion 24. First and second vertical engaging surfaces 68, 70 are convex curved corresponding to a circle, and their cross section defines a chord of a circle having a radius corresponding to the radius of the mounting collar for the under-sink appliance (in this example garbage disposal coupling M). In the embodiment, the radius, represented by dashed line 72 in FIG. 15, is approximately 3 inches (76 mm), corresponding to a standard garbage disposal interior throat diameter in the U.S. In practice, “corresponds to” means slightly less than the selected drain connection diameter, so that shoe central portion 24 with first and second vertical engagement surfaces 68 and 70 can be positioned inside the drain connection for alignment.

First and second shoulder top engagement surfaces 34, 36, respectively, are convexly curved relative to their linear axes, which provides better engagement to the interior conical throat surface of a typical garbage disposal A.

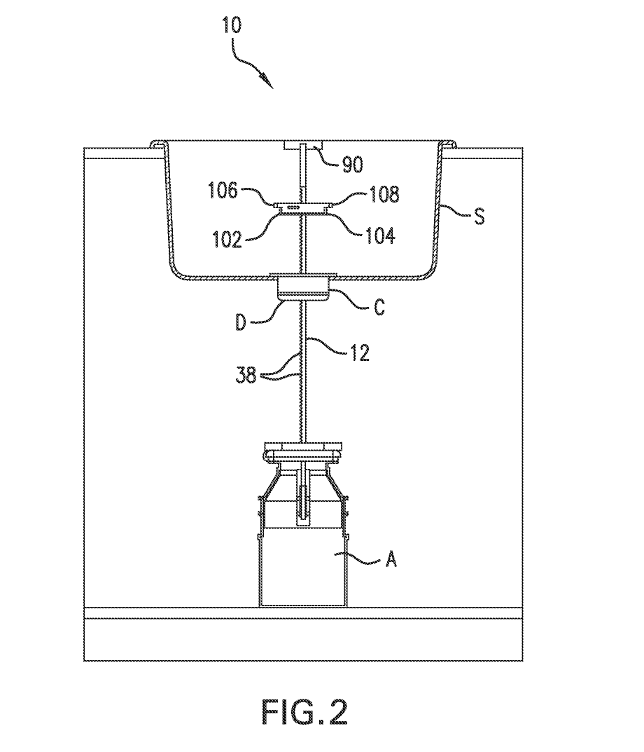

Referring to FIGS. 1-12 and 14-15, shoe 18 is rotatingly coupled to elongated member 12 proximate its second end 16 by axle pin 74 through bearing races 76 and 78 within elongated member 12 (proximate second end 16) and shoe central portion 24, respectively. Axle pin 74 and races 76 and 78 together define the rotational coupling pivot axis 80, about which shoe 18 rotates between an in-line orientation (i.e. rotated toward being parallel with elongated member 12) for insertion/extraction and a deployed orientation substantially perpendicular to elongated member 12 for engaging and lifting appliance A. Shoe 18 includes receiving slot 82 extending along a portion of shoe central portion 24. In the embodiment, receiving slot 82 extends from proximate the rotational coupling 74/76/78 through first vertical engaging surface 68. Elongated member 12 is partially recessed into receiving slot 82 when shoe 18 is rotated to an in-line orientation (as shown in FIGS. 1-2), allowing shoe 18 to rotate to nearly vertical during insertion/extraction. Aperture 84 penetrates through shoe central portion 24 along the interior of receiving slot 82, providing drainage and further enhancing the asymmetrical weighting of shoe 18.

In the embodiment, shoe 18 is asymmetrically weighted about pivot axis 80, causing shoe 18 to preferentially tend toward an in-line orientation (shown in FIGS. 1-2). Extending receiving slot 82 only through one side of shoe central portion 24 provides asymmetrical weighting. This asymmetry is enhanced by first and second cutouts 86, 88, respectively, in shoe central portion 24 proximate first vertical engaging surface 68 and first shoulder 26, as well as aperture 84, also proximate first shoulder 26.

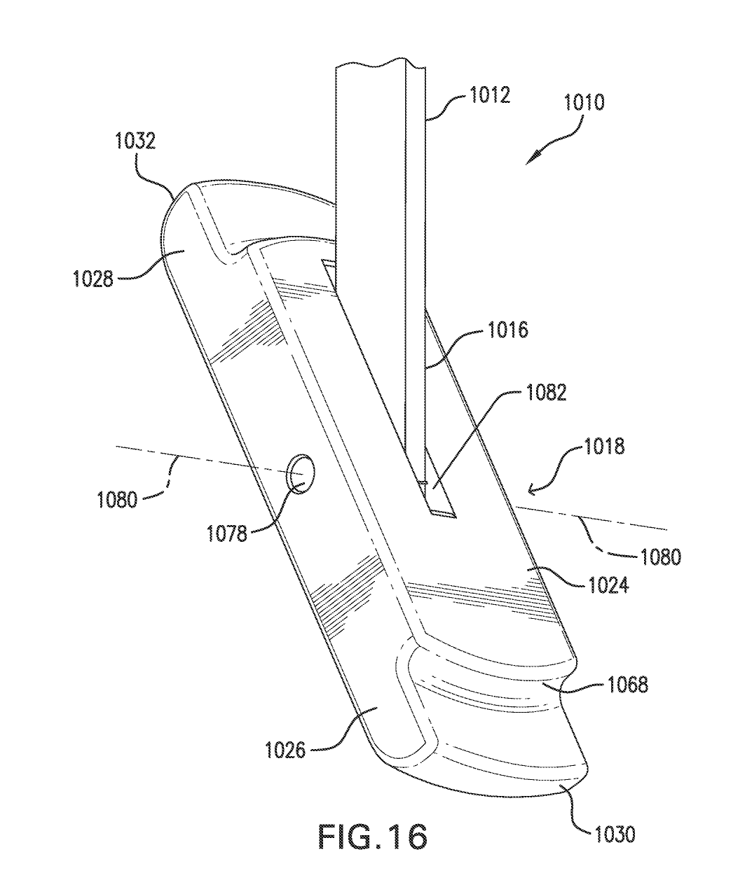

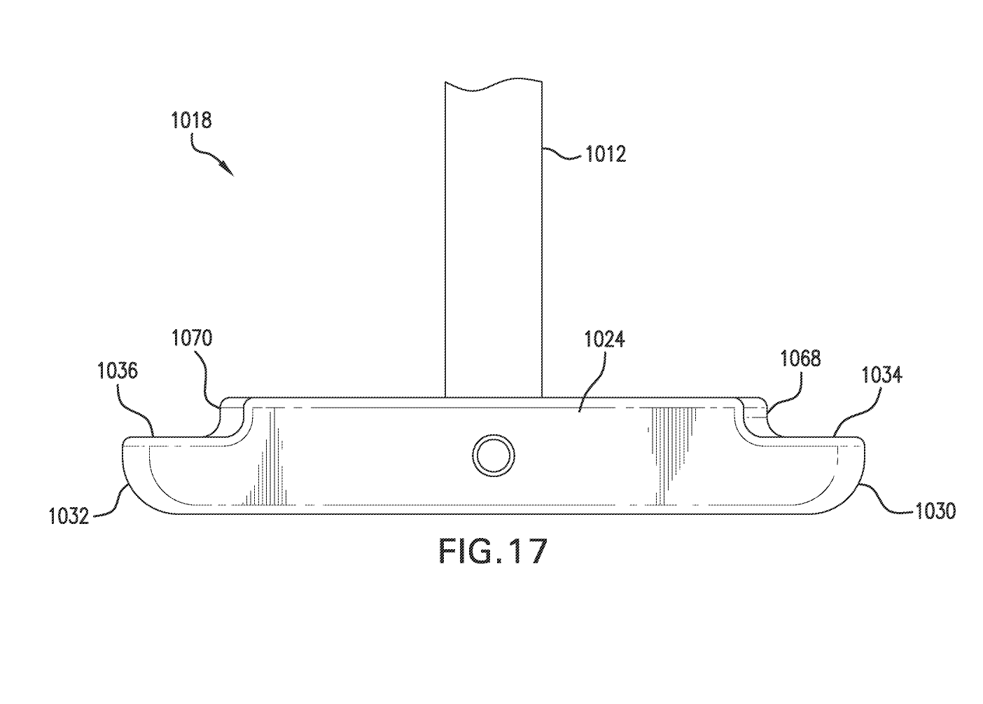

Referring to FIGS. 16-17, the shoe portion 1018 of a Second Embodiment 1010 is shown. In the Second Embodiment, elongated member 1012 is a rigid shaft extending from a first end 1014 (not shown) to a second end 1016, having shoe 1018 rotationally coupled proximate elongated member second end 1016 at pivot axis 1080. Shoe 1018 is generally similar to shoe 18 of First Embodiment 10, having a shoe central portion 1024 and first and second shoulders 1026, 1028, respectively, extending outward from shoe central portion 1024 to terminal ends 1030, 1032, respectively. In the embodiment, first and second shoulder top engagement surfaces 1034 and 1036, respectively, are substantially horizontal rather than sloped. Shoe central portion first and second vertical engagement surfaces 1068, 1070, respectively, extend upward proximate the region where first and second shoulders 1026, 1028 extend from shoe central portion 1024. Shoe central portion first and second vertical engagement surfaces 1068, 1070 are convex curved, and with shoe central portion 1024 define a chord having a radius 1072 corresponding to the radius R_{M} of a desired under sink appliance A. Receiving slot 1082 extends partially along shoe central portion 1024, symmetrically about pivot axis 1080, to permit rotation of shoe 1018 between an in-line orientation (shown in FIG. 16) and a deployed orientation (shown in FIG. 17). In this case, “in-line” is oriented toward parallel with elongated member 1012, but does not reach parallel.

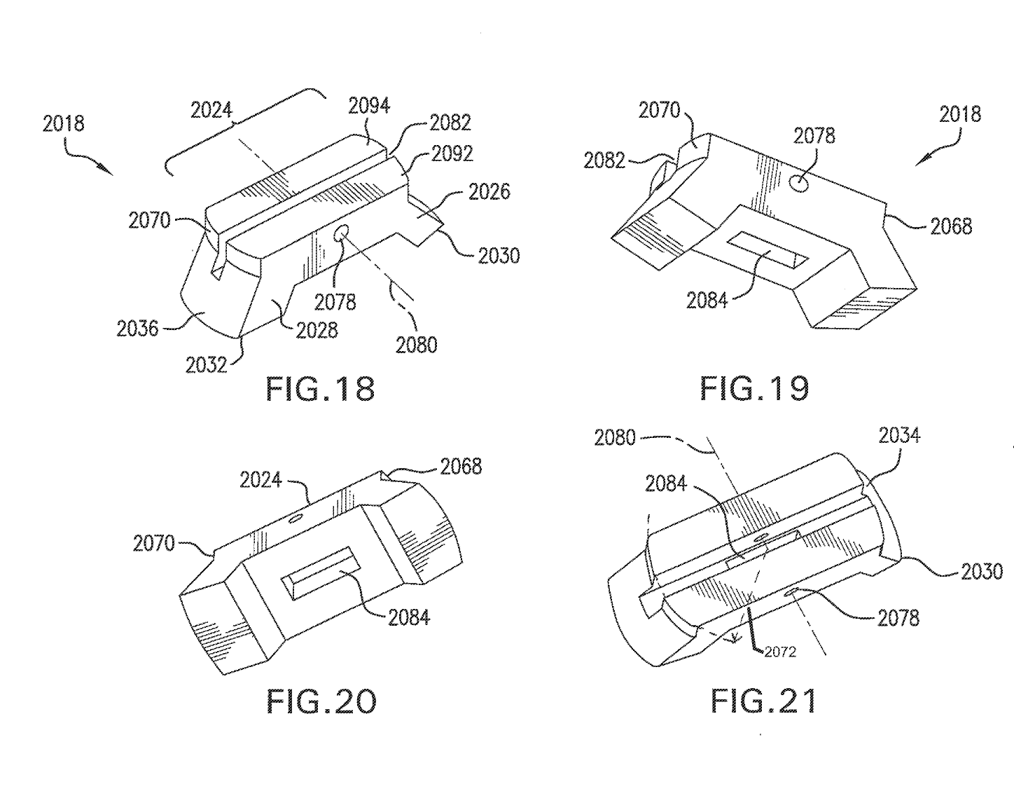

Referring to FIGS. 18-21 a shoe 2018 of a Third Embodiment 2010 is shown. In the Third Embodiment, shoe 2018 includes a central portion 2024 and opposite first and second shoulders 2026, 2028, respectively extending from shoe central portion 2024 to first and second should terminal ends 2030, 2032, respectively. Center portion first and second vertical engaging surfaces 2068 and 2070, respectively, project upward proximate shoulders 2026, 2028, defining a circular chord having radius R_{M} corresponding to the interior walls of a selected appliance mounting collar M.

Opposed first and second shoe central portion sidewalls 2092 and 2094, respectively, define open receiving slot 2082, extending along the entire length of shoe central portion 2024, permitting shoe 2018 to rotate about rotational coupling pivot axis 2080 in either direction toward an inline orientation for insertion and extraction. In the embodiment, first and second vertical engaging surfaces 2068, 2070 and sidewalls 2092, 2094 define the middle cord of a circle having radius corresponding to radius R_{M}, so that shoe central portion 2024 will automatically center shoe 2018 within mounting collar M. Aperture 2084 extending through shoe 2018 provides drainage and clearance for the rotational coupling through bearing race 2078.

First and second shoulder portion top engagement surfaces 2034, 2036 slope downward toward respective first and second shoulder portion terminal ends 2030, 2032, and so adapted to easily engage typical garbage disposal units which generally include a conical upper interior throat portion. In the embodiment, first and second shoulder portion top engagement surfaces 2034, 2036 are convexly curved transversely (i.e. perpendicular to the shoulder-to-shoulder axis), so they approximate the concave conical interior wall surface commonly found in garbage disposals (approximate because a cone has a non-constant cross section radius).

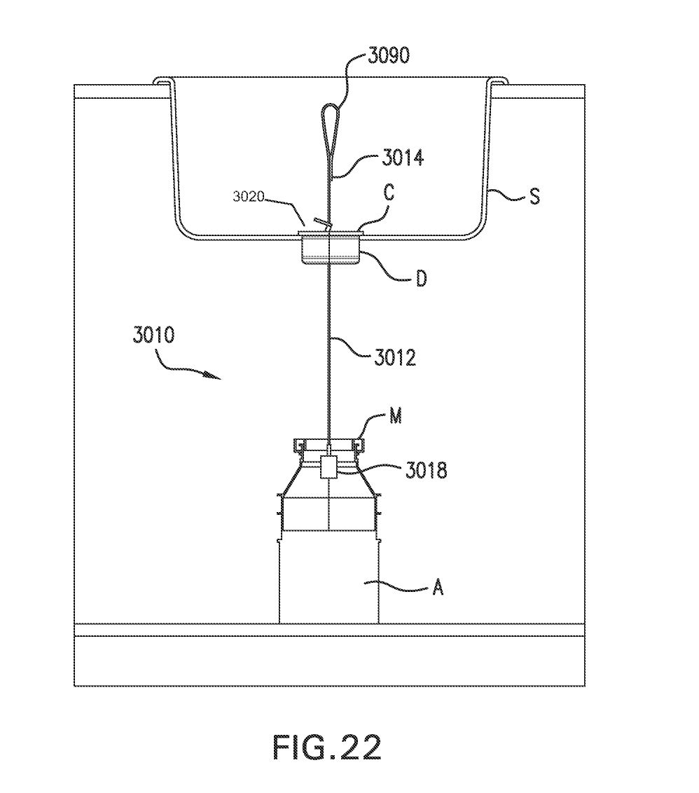

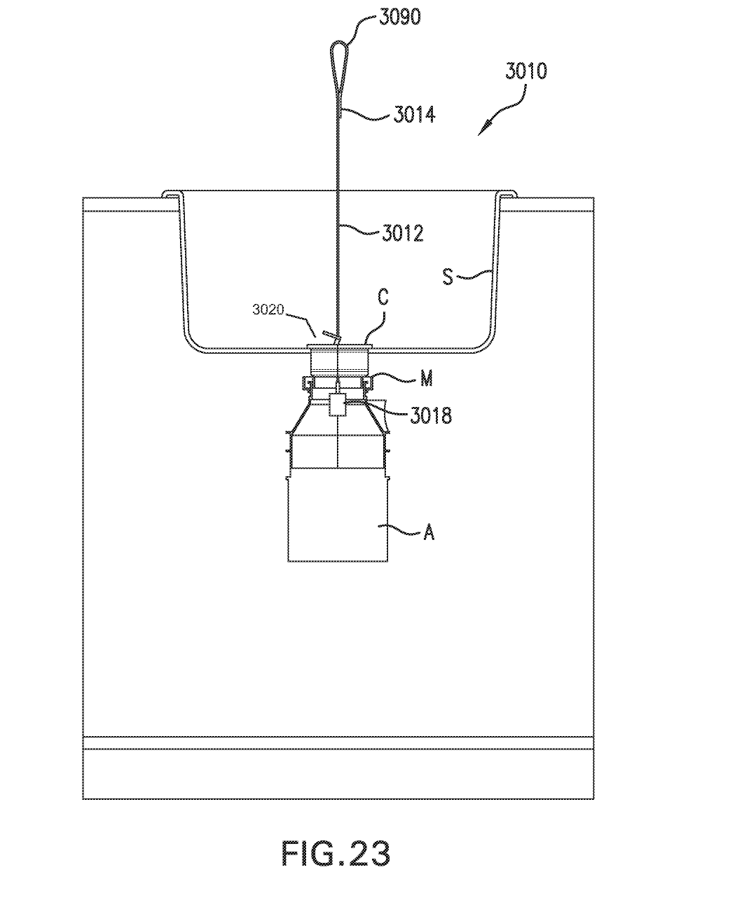

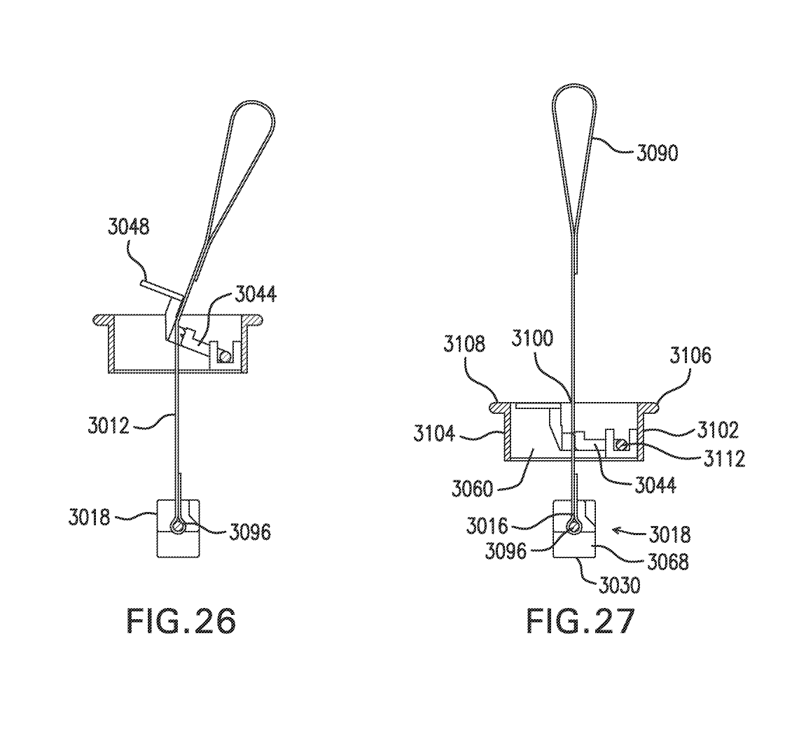

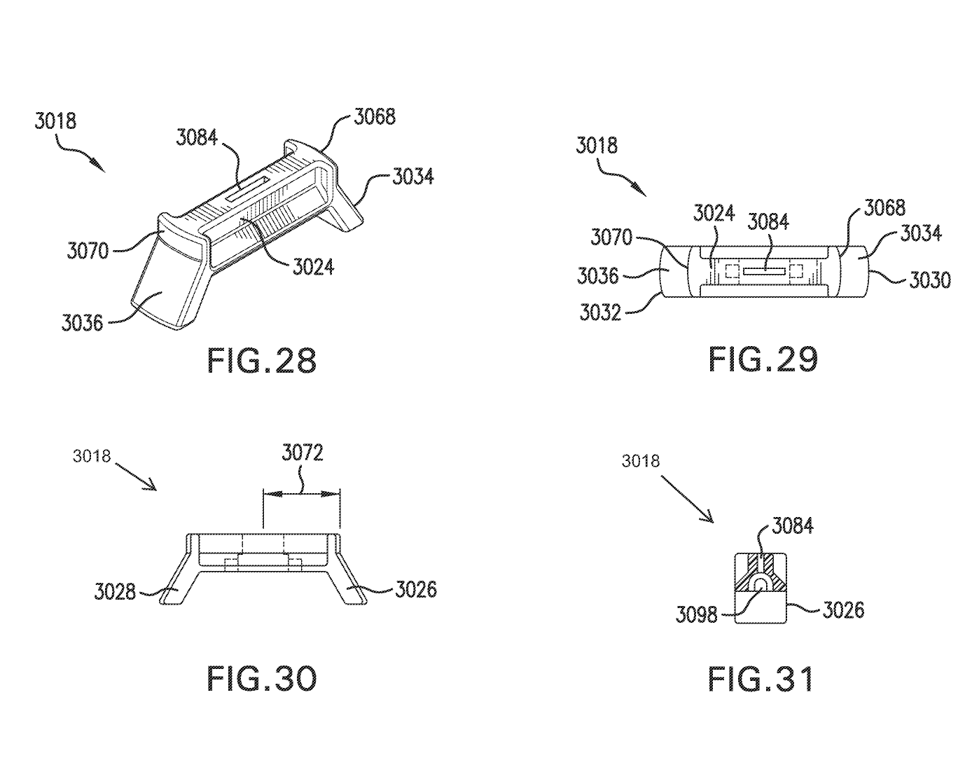

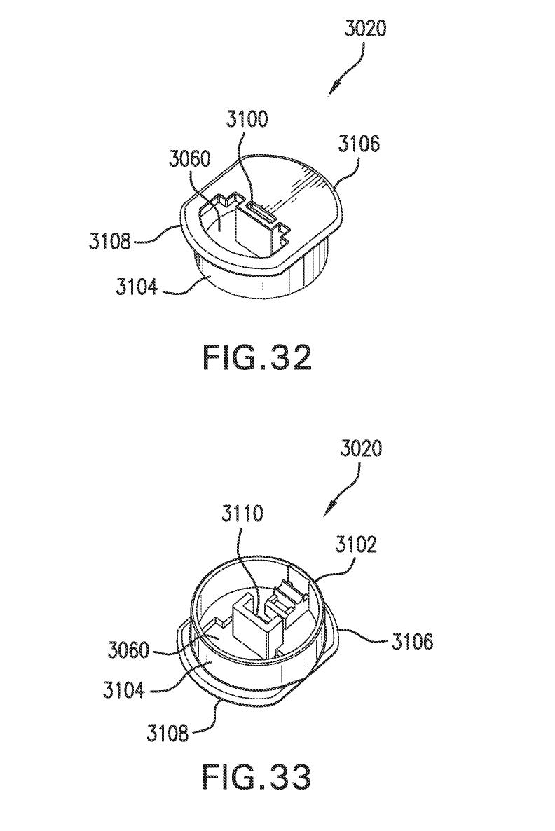

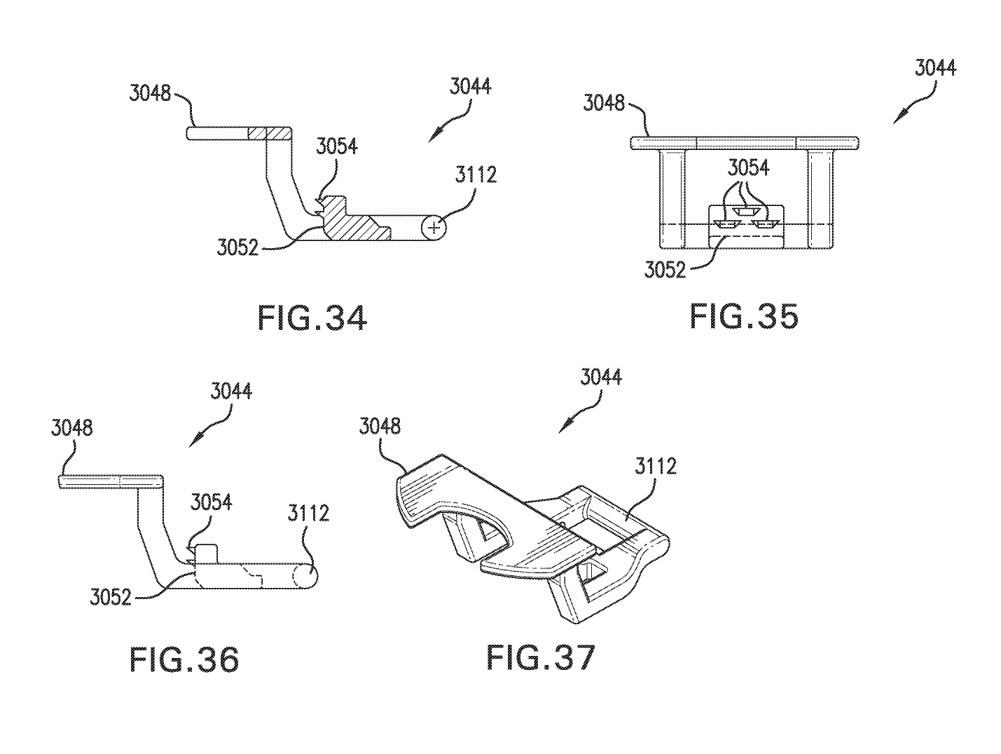

Referring to FIGS. 22-37, a Fourth Embodiment 3010 is shown. The Fourth Embodiment includes an elongated member 3012 extending from a first end 3014 to a second end 3016, a shoe 3018 couplable to elongated member 3012, a centering portion 3020 slidingly mounted onto elongated member 3012 between the elongated member first end 3014 and shoe 3018, and a locking portion 3022 engagable along elongated member 3012 and engagable to centering portion 3020.

In the embodiment, elongated member 3012 is a flexible strap. In this context, “strap” is intended to refer to straps, cables, ropes, wire ropes, chains and other flexible members which are intended to carry primarily tensile loads. Elongated member 3012 includes a handle 3090 proximate first end 3014, which in the embodiment is a loop. Providing a loop as a handle 3090 allows the user to hold the apparatus with his hand, or to suspend the apparatus from a hook, bar, or other structure during operation.

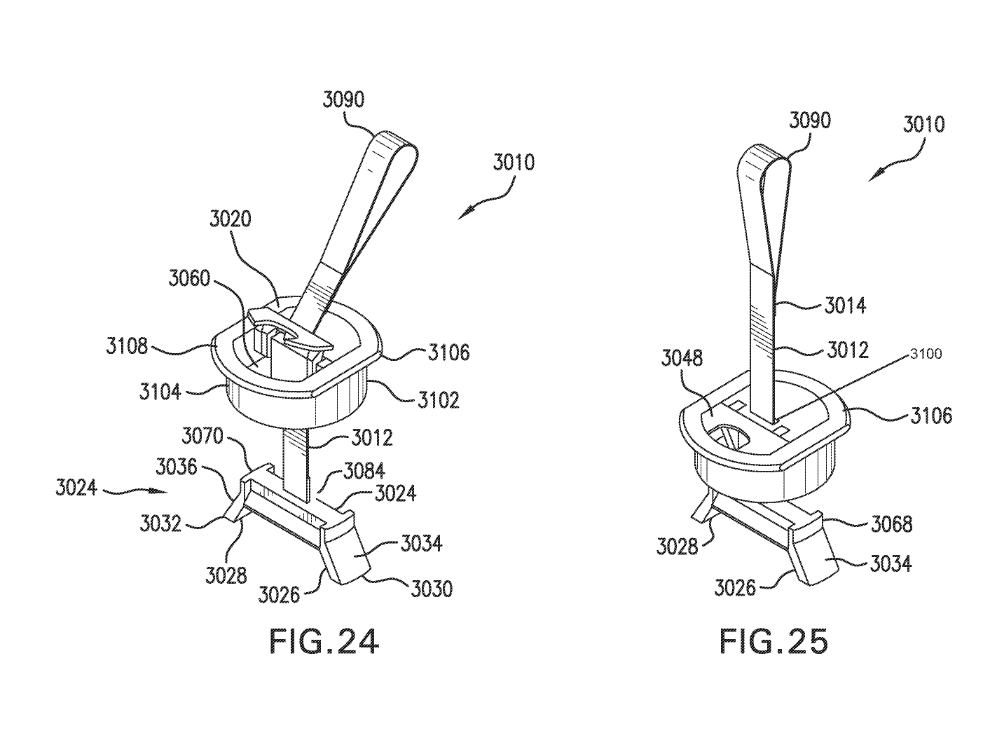

Referring again to FIGS. 22-37, and particularly to FIGS. 24-31, shoe 3018 is similar to those described in the First Embodiment (18) and Third Embodiment (2018). Shoe 3018 includes a shoe central portion 3024 and opposing first and second shoulder portions 3026, 3028 extending from shoe central portion 3024 to respective first and second shoulder portion terminal ends 3030, 3032. First and second shoulder portions include sloped first and second should portion top engagement surfaces 3034, 3036, respectively. Shoe central portion 3024 projects vertically beyond shoulder portions 3026, 3028, adapted to fit within the interior walls of a selected appliance mounting collar M, extending from a first vertical engaging surface 3068 to an opposing second vertical engaging surface 3070. The distance between first and second vertical engaging surfaces 3068 and 3070 corresponds to the inside radius of a selected appliance mounting collar M. In practice, “corresponds to” means slightly less than the selected drain connection diameter, so that shoe central portion 3024 can be positioned inside the drain connection for alignment.

Aperture 3084 extends through shoe 3018 from top to bottom, to receive elongated member 3012 there through. Recess 3098, open to the bottom side of shoe 3018 and aperture 3084, is provided to receive anchor 3096 which is proximate elongated member second end 3016. In the embodiment, elongated member second end 3016 forms a terminal loop, and anchor 3096 is a plastic cross-bar inserted through the terminal loop and glued or welded at its ends into recess 3098. Anchor 3096 may include a ball insertable into a socket/recess 3098, or a plate, or similar interference member having sufficient strength. Using a terminal loop 3016 and anchor/cross-bar 3096 provides certain advantages, including simplified construction and that a cross-bar acts as a load-carrying axle which does avoids locked in stresses (because elongated member second end/terminal loop 3016 can rotate about the cross-bar 3096) and does not pinch elongated member/strap 3012.

Referring to in the embodiment, shoe central portion first and second vertical engaging surfaces 3068 and 3070 define the middle cord of a circle with radius 3072 corresponding to the inside radius R_{M} of a selected appliance mounting collar M, so that shoe central portion 3024 will automatically center shoe 3018 within mounting collar M. In the embodiment, the diameter of shoe central portion 3024 is approximately 3 inches (76 mm), to fit a an appliance sized for a standard 3.25 inch (88 mm) drain connection, but can be sized to fit any selected fitting.

Referring again to FIGS. 22-37, and particularly to FIGS. 24-27 and 32-37, a centering portion 3020 of a Third Embodiment is shown. Centering portion 3020 is slidingly mountable to elongated member 3012 between shoe 3018 and elongated member first end 3014 through centering portion aperture 3100. Centering portion 3020 includes opposed first and second centering portion vertical engagement surfaces 3102 and 3104, respectively, which in the embodiment extend completely around to form a continuous round projecting flange. Centering portion 3020 includes opposed first and second lateral flanges 3106 and 3108 extending radially outward beyond first and second centering portion vertical engagement surfaces 3102, 3104, to support the centering portion 3020 and the weight of the under-sink appliance A to be installed. The distance between the first and second vertical engagement surfaces 3102 and 3104 is approximately equal the interior diameter of the selected drain fitting. In the embodiment, vertical engagement surfaces 3102, 3104 form an enclosed circular wall sized to fit snugly within a standard domestic sink drain.

In the embodiment, locking portion 3022 is contained within centering portion 3020 in latch cavity 3060, and is selectively engagable against elongated member 3012 along elongated member 3012. Centering portion 3020 includes a centering portion aperture 3100 to receive the elongated member 3012 there through, and a clamping surface 3110 proximate centering portion aperture 3100 which is normally in contact with elongated member 3012 when elongated member 3012 is inserted through centering portion 3020. In the embodiment, clamping surface 3110 extends below centering portion aperture 3100.

Locking portion 3022 includes a pawl latch 3044 pivotably coupled to centering portion 3020 at axle 3112, defining the pawl latch pivot axis, and pivotable between an engaged position and a disengaged position. Pawl latch 3044 is located proximate centering portion clamping surface 3110, such that elongated member 3012 passes between pawl latch engagement surface 3052 and centering portion clamping surface 3110. In the engaged position, pawl latch engagement surface 3052 compresses elongated member 3012 against clamping surface 3110 thereby locking elongated member 3012 in place by force of gravity.

Pawl latch 3044 includes rigidly connected latch manual tab 3048 to move pawl latch 3044 between at least an engaged and a disengaged position. In the embodiment, pawl latch engagement surface 3052 includes a plurality of latch engagement teeth 3054 projecting outward to positively grip elongated member 3012. In the embodiment, the depth of teeth 3054 is less than the thickness of elongated member 3012.

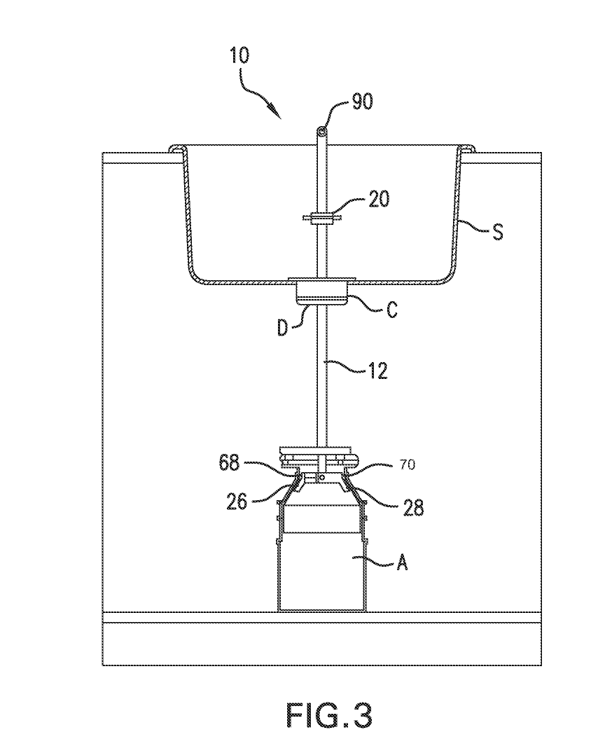

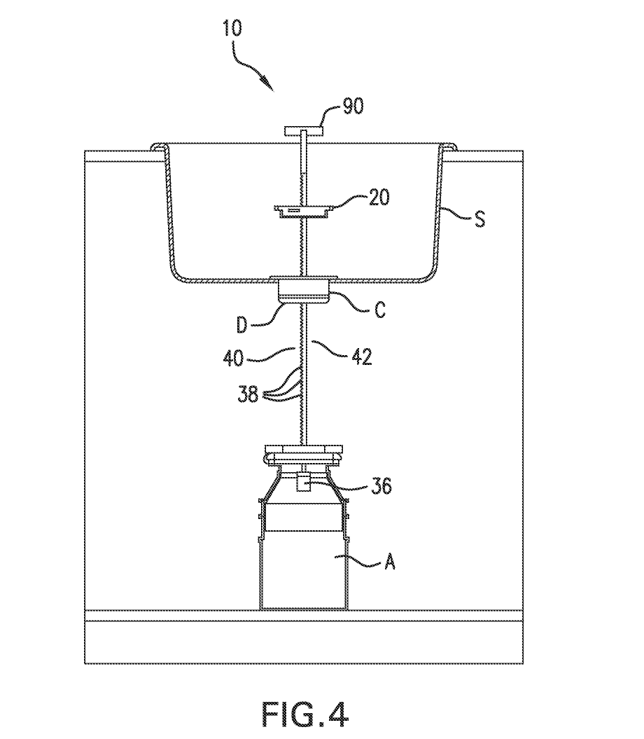

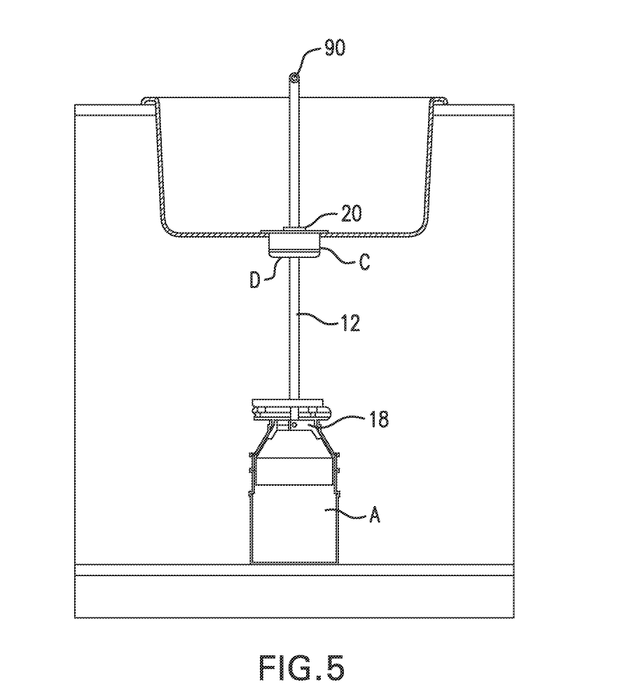

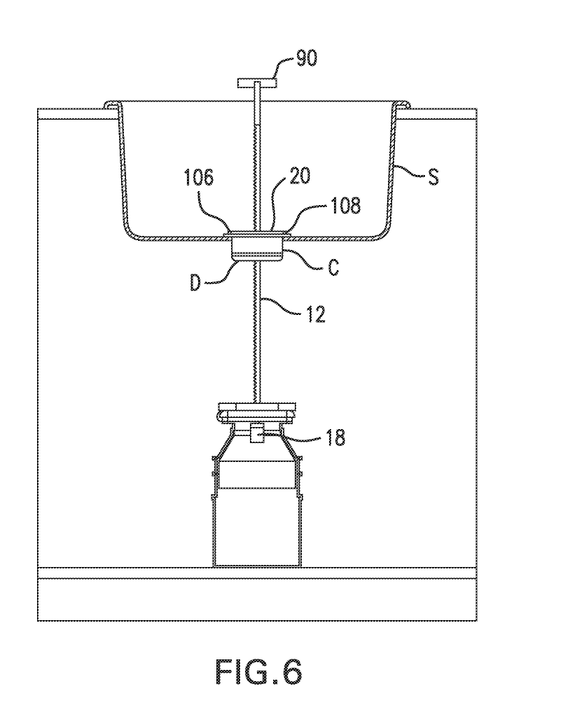

Referring to FIGS. 1-15, and particularly to FIGS. 1-12, operation of a First Embodiment 10 is described by example. Place the appliance A below sink S approximately below the drain connection D to which it will be attached. It is not necessary to align the disposal precisely with drain connection D. Ensure the centering portion 20 is appropriate for the sink drain connection D profile—if not, select the proper centering portion 20 and swap it out. Grip apparatus 10 by handle 90. Ensure shoe 18 is oriented toward the in-line position, with second shoulder portion 28 lower than first shoulder portion 26, and insert shoe 18 and elongated member 12 through the drain connection D and into the mounting collar M of appliance A (FIGS. 1-2). With shoulder portion 26 of shoe 18 against the edge of mounting collar M, apply slight upward pressure to rotate shoe 18 about pivot axis 80 into a horizontal position and are firm until shoe center portion 24 inserts into mounting collar M and first and second shoulder portion top engagement surfaces 34, 36 engage against the interior throat of appliance A (FIGS. 3-4). Slide centering portion 20 down elongated member 12 until first and second centering portion lateral flanges 106, 108 are firmly against the sink base, and centering portion first and second vertical engagement surfaces 102, 104 are snug inside drain cup C (FIGS. 5-6).

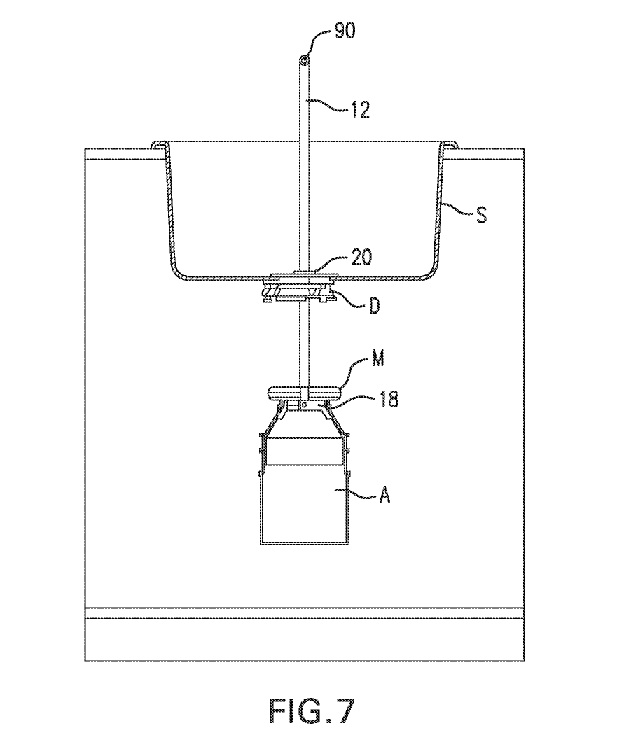

While holding centering portion 20 in place with one hand, the operator lifts appliance A into place against drain D by lifting elongated member handle 90. The lift can be done in smaller stages, because locking portion 22 will automatically engage the elongated member gear teeth 38 if the operator stops pulling up on handle 90, thereby locking the apparatus in place to hold appliance A in situ (FIGS. 7-10). When appliance collar M is firmly against drain D, elongated member handle 90 can be released and appliance A will remain in place.

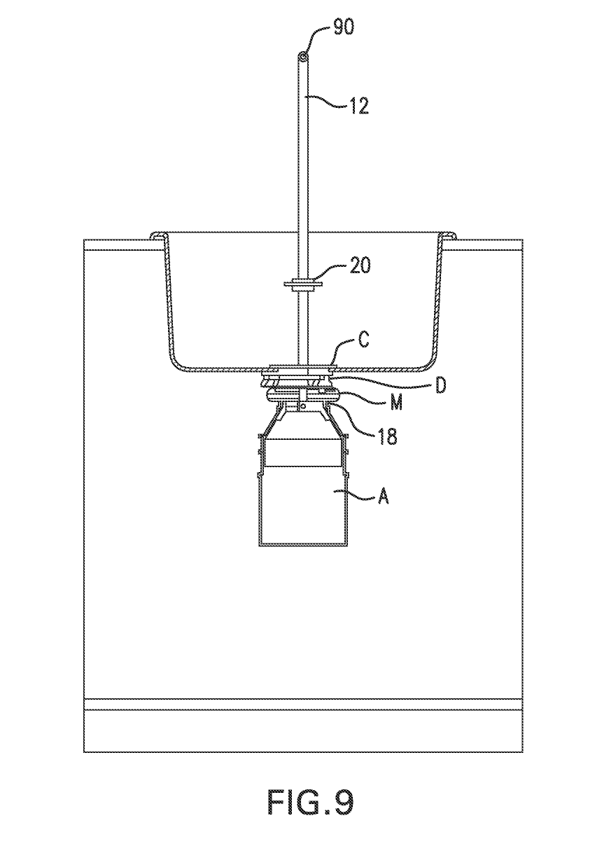

After connecting appliance A to drain D, the operator disengages latch 22 by operating first and second manual latch tabs 48, 50 with his/her fingers and disengages shoe 18 by pushing elongated member 12 downward using handle 90. After disengagement, shoe 18 will naturally rotate toward an in-line/vertical orientation due to the asymmetric weighting and the apparatus can be removed (FIGS. 9-12).

Those skilled in the art will recognize that the steps of operation may vary depending on the type of appliance A and the connection methods used.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

We claim:

1. An apparatus, comprising:
an elongated member extending from a first end to a second end;
a shoe couplable to the elongated member proximate the elongated member second end, the shoe including a central portion and first and second shoulder portions, each shoulder portion extending from the central portion to its respective terminal end distal from the center portion, each of the first and second shoulder portions further including a respective top engagement surface;
a centering portion slidingly mountable to the elongated member between the shoe and the elongated member first end, the centering portion including at least first and second centering portion vertical engagement surfaces and at least first and second lateral flanges extending outward beyond the at least first and second centering portion vertical engagement surfaces, and the centering portion further including a locking portion selectively engagable against the elongated member along at least a portion of its length.

2. The apparatus of claim 1, the locking portion further comprising a latch movable at least between an engaged position and a disengaged position.

3. The apparatus of claim 2, the latch further comprising a biasing portion, the biasing portion disposed to bias the latch toward the engaged position.

4. The apparatus of claim 2, further comprising:
wherein the elongated member comprises a linear rack including a plurality of gear teeth to engage the latch.

5. The apparatus of claim 4, further comprising:
wherein the latch comprises a pawl, the pawl and elongated member gear teeth oriented to permit the elongated member to move freely in the direction of the elongated member first end and to prevent free movement in the direction of the elongated member second end.

6. The apparatus of claim 2, further comprising:
wherein the latch is linearly movable along the centering portion between at least the engaged and disengaged positions; and,
the latch including at least one exposed manual tab coupled to the latch and accessible for manual movement of the latch between at least the engaged and disengaged position.

7. The apparatus of claim 6, further comprising:
a biasing member oriented to act against the latch to bias the latch toward the engaged position.

8. The apparatus of claim 6, further comprising:
wherein the centering portion includes a latch cavity, wherein the latch and biasing member are disposed within the cavity.

9. The apparatus of claim 8, further comprising:
wherein the latch cavity includes a removable cover plate.

10. The apparatus of claim 1, further comprising:
wherein the elongated member is selected from the group consisting of a semi-rigid shaft, a flat strap, a cable and a chain.

11. The apparatus of claim 2, further comprising:
the shoe central portion including an aperture extending through the center portion from top to bottom; and,
the elongated member extending through the shoe central portion aperture, and the elongated member second end including an anchor engagable against the bottom side of the shoe central portion.

12. The apparatus of claim 1, further comprising:
the shoe rotatingly coupled to the elongated member proximate the elongated member second end, the rotational coupling defining a pivot axis, such that the shoe is able to rotate at least between an in-line orientation and a deployed orientation.

13. The apparatus of claim 12, further comprising:
wherein the shoe central portion further includes a elongated member receiving slot extending at least from the shoe pivotable coupling to one of the first or second shoulder portions.

14. The apparatus of claim 13, further comprising:
the shoe further including a receiving slot extending along at least a portion of the shoe central portion, wherein the elongated member is at least partially recessed into the receiving slot when the shoe is fully rotated to an in-line orientation.

15. The apparatus of claim 14, further comprising:
wherein the shaft receiving slot comprises an open ended slot extending from the first shoulder portion to the second shoulder portion.

16. The apparatus of claim 12, further comprising:
wherein the shoe is asymmetrically weighted about the pivot axis to bias the shoe toward an in-line orientation.

17. The apparatus of claim 2, further comprising:
the centering portion having a centering portion aperture to receive the elongated member there through and a clamping surface proximate the centering portion aperture in contact with the elongated member;
the locking portion comprising a pawl latch pivotably coupled to the centering portion, the pawl latch rotatable about its pivot point between at least a disengaged position and an engaged position and including an engagement surface, wherein the pawl latch is disposed proximate the centering portion clamping surface to compress the elongated member against the clamping surface by the pawl latch engagement surface when in the engaged position, the pawl latch further including a tab rigidly connected to the pawl latch to move the pawl latch between at least an engaged and a disengaged position.

18. The apparatus of claim 17, further comprising:
the latch engagement surface including at least one tooth.

19. The apparatus of claim 17, further comprising:
the latch engagement surface including at least one tooth.

20. The apparatus of claim 1, further comprising:
wherein each of the shoe first and second shoulder portions top engagement surfaces is sloped downward toward its respective terminal end.

21. The apparatus of claim 1, further comprising:
wherein the shoe central portion includes first and second vertical engaging surfaces disposed at opposite positions, the first and second vertical engaging surfaces extending upward from the respective shoulders.

22. The apparatus of claim 21, further comprising:
wherein the cross-section of the shoe central portion from the first vertical engagement surface to the second vertical engaging surface defines a middle cord of a circle of radius corresponding to a selected appliance mounting collar

23. The apparatus of claim 22, further comprising:
wherein the first and second vertical engaging surface radius is approximately 3 inches (76 mm).

24. The apparatus of claim 1, further comprising:
wherein each of the shoe first and second shoulder portions top engagement surfaces is sloped downward toward its respective terminal end.

25. The apparatus of claim 24, further comprising:
wherein the sloped top engagement surfaces are curved convexly.

26. The apparatus of claim 1, further comprising:
a handle disposed proximate the shaft first end.
